(19) United States
(12) Patent Application Publication
(10) Pub. No.: US 2025/0254642 A1
(43) Pub. Date: Aug. 7, 2025

(54) POSITIONING OF COLLABORATING DEVICES WITH SIDELINK

(71) Applicant: Nokia Technologies Oy, Espoo (FI)

(72) Inventors: Oana-Elena BARBU, Aalborg (DK); Benny VEJLGAARD, Gistrup (DK); Johannes HARREBEK, Aalborg (DK)

(21) Appl. No.: 18/854,460

(22) PCT Filed: Apr. 7, 2022
(86) PCT No.: PCT/EP2022/059222

§ 371 Date: Oct. 4, 2024

(51) Int. Cl. H04W 64/00

(52) U.S. Cl. CPC H04W 64/00

(57) ABSTRACT

Disclosed is a method comprising receiving, from a first terminal device, an indication comprising information regarding a cluster comprising the first terminal device and a second terminal device, wherein the cluster is capable of performing a combined positioning and ranging session, defining, based on the indication, for the combined positioning and ranging session, a first configuration for the first terminal device and a second configuration for the second terminal device, transmitting a first request for deploying the combined positioning and ranging session to a first access node serving the first terminal device, and a second request for deploying the combined positioning and ranging session to a second access node serving the second terminal device, and transmitting, to the first terminal device, for deployment of the combined positioning and ranging session, assistance information comprising the first configuration and the second configuration.

### FIELD

The following exemplary embodiments relate to wireless communication and positioning of wireless devices.

### BACKGROUND

Cellular communication networks evolve, and the network structure may comprise not only terminal devices as such but also a group of terminal devices that collaborate together for better resources usage. Better usage of resources may be beneficial in various use cases as it may allow improved network capability.

### BRIEF DESCRIPTION

The scope of protection sought for various embodiments of the invention is set out by the independent claims. The exemplary embodiments and features, if any, described in this specification that do not fall under the scope of the independent claims are to be interpreted as examples useful for understanding various embodiments of the invention.

According to a first aspect there is provided an apparatus comprising means for: receiving, from a first terminal device, an indication comprising information regarding a cluster comprising the first terminal device and a second terminal device, wherein the cluster is capable of performing a combined positioning and ranging session, defining, based on the indication, for the combined positioning and ranging session, a first configuration for the first terminal device and a second configuration for the second terminal device, transmitting a first request for deploying the combined positioning and ranging session to a first access node serving the first terminal device, and a second request for deploying the combined positioning and ranging session to a second access node serving the second terminal device, and transmitting, to the first terminal device, for deployment of the combined positioning and ranging session, assistance information comprising the first configuration and the second configuration.

In some exemplary embodiments according to the first aspect, the means comprises at least one processor, and at least one memory, including a computer program code, wherein the at least one memory and the computer program code are configured, with the at least one processor, to cause the performance of the apparatus.

According to a second aspect there is provided an apparatus comprising at least one processor, and at least one memory including a computer program code, wherein the at least one memory and the computer program code are configured, with the at least one processor, to cause the apparatus to: receive, from a first terminal device, an indication comprising information regarding a cluster comprising the first terminal device and a second terminal device, wherein the cluster is capable of performing a combined positioning and ranging session, define, based on the indication, for the combined positioning and ranging session, a first configuration for the first terminal device and a second configuration for the second terminal device, transmit a first request for deploying the combined positioning and ranging session to a first access node serving the first terminal device, and a second request for deploying the combined positioning and ranging session to a second access node serving the second terminal device, and transmit, to the first terminal device, for deployment of the combined positioning and ranging session, assistance information comprising the first configuration and the second configuration.

According to a third aspect there is provided a method comprising: receiving, from a first terminal device, an indication comprising information regarding a cluster comprising the first terminal device and a second terminal device, wherein the cluster is capable of performing a combined positioning and ranging session, defining, based on the indication, for the combined positioning and ranging session, a first configuration for the first terminal device and a second configuration for the second terminal device, transmitting a first request for deploying the combined positioning and ranging session to a first access node serving the first terminal device, and a second request for deploying the combined positioning and ranging session to a second access node serving the second terminal device, and transmitting, to the first terminal device, for deployment of the combined positioning and ranging session, assistance information comprising the first configuration and the second configuration.

According to a fourth aspect there is provided a computer program comprising instructions for causing an apparatus to perform at least the following: receive, from a first terminal device, an indication comprising information regarding a cluster comprising the first terminal device and a second terminal device, wherein the cluster is capable of performing a combined positioning and ranging session, define, based on the indication, for the combined positioning and ranging session, a first configuration for the first terminal device and a second configuration for the second terminal device, transmit a first request for deploying the combined positioning and ranging session to a first access node serving the first terminal device, and a second request for deploying the combined positioning and ranging session to a second access node serving the second terminal device, and transmit, to the first terminal device, for deployment of the combined positioning and ranging session, assistance information comprising the first configuration and the second configuration.

According to a fifth aspect there is provided a computer program comprising instructions stored thereon for performing at least the following: receiving, from a first terminal device, an indication comprising information regarding a cluster comprising the first terminal device and a second terminal device, wherein the cluster is capable of performing a combined positioning and ranging session, defining, based on the indication, for the combined positioning and ranging session, a first configuration for the first terminal device and a second configuration for the second terminal device, transmitting a first request for deploying the combined positioning and ranging session to a first access node serving the first terminal device, and a second request for deploying the combined positioning and ranging session to a second access node serving the second terminal device, and transmitting, to the first terminal device, for deployment of the combined positioning and ranging session, assistance information comprising the first configuration and the second configuration.

According to a sixth aspect there is provided a non-transitory computer readable medium comprising program instructions for causing an apparatus to perform at least the following: receive, from a first terminal device, an indication comprising information regarding a cluster comprising the first terminal device and a second terminal device, wherein the cluster is capable of performing a combined positioning and ranging session, define, based on the indication, for the combined positioning and ranging session, a first configuration for the first terminal device and a second configuration for the second terminal device, transmit a first request for deploying the combined positioning and ranging session to a first access node serving the first terminal device, and a second request for deploying the combined positioning and ranging session to a second access node serving the second terminal device, and transmit, to the first terminal device, for deployment of the combined positioning and ranging session, assistance information comprising the first configuration and the second configuration.

According to a seventh aspect there is provided a non-transitory computer readable medium comprising program instructions stored thereon for performing at least the following: receiving, from a first terminal device, an indication comprising information regarding a cluster comprising the first terminal device and a second terminal device, wherein the cluster is capable of performing a combined positioning and ranging session, defining, based on the indication, for the combined positioning and ranging session, a first configuration for the first terminal device and a second configuration for the second terminal device, transmitting a first request for deploying the combined positioning and ranging session to a first access node serving the first terminal device, and a second request for deploying the combined positioning and ranging session to a second access node serving the second terminal device, and transmitting, to the first terminal device, for deployment of the combined positioning and ranging session, assistance information comprising the first configuration and the second configuration.

According to an eight aspect there is provided an apparatus comprising means for: identifying, using sidelink connectivity, an aiding terminal device for creating a cluster of collaborating terminal devices, wherein the cluster is capable of deploying a combined positioning and ranging session, creating, using the sidelink connectivity, the cluster with the aiding terminal device, transmitting an indication to a network entity, wherein the indication comprises information regarding the collaborating terminal devices comprised in the cluster and information indicating capabilities of the collaborating terminal devices comprised in the cluster, receiving, from the network entity, assistance information for deploying the combined positioning and ranging session, wherein the assistance information comprises a first configuration for the apparatus and a second configuration for the aiding terminal device, and transmitting the second configuration to the aiding terminal device.

In some exemplary embodiments according to the first aspect, the means comprises at least one processor, and at least one memory, including a computer program code, wherein the at least one memory and the computer program code are configured, with the at least one processor, to cause the performance of the apparatus.

According to a ninth aspect there is provided an apparatus comprising at least one processor, and at least one memory including a computer program code, wherein the at least one memory and the computer program code are configured, with the at least one processor, to cause the apparatus to: identify, using sidelink connectivity, an aiding terminal device for creating a cluster of collaborating terminal devices, wherein the cluster is capable of deploying a combined positioning and ranging session, create, using the sidelink connectivity, the cluster with the aiding terminal device, transmit an indication to a network entity, wherein the indication comprises information regarding the collaborating terminal devices comprised in the cluster and information indicating capabilities of the collaborating terminal devices comprised in the cluster, receive, from the network entity, assistance information for deploying the combined positioning and ranging session, wherein the assistance information comprises a first configuration for the apparatus and a second configuration for the aiding terminal device, and transmit the second configuration to the aiding terminal device.

According to a tenth aspect there is provided a method comprising: identifying, using sidelink connectivity, an aiding terminal device for creating a cluster of collaborating terminal devices, wherein the cluster is capable of deploying a combined positioning and ranging session, creating, using the sidelink connectivity, the cluster with the aiding terminal device, transmitting an indication to a network entity, wherein the indication comprises information regarding the collaborating terminal devices comprised in the cluster and information indicating capabilities of the collaborating terminal devices comprised in the cluster, receiving, from the network entity, assistance information for deploying the combined positioning and ranging session, wherein the assistance information comprises a first configuration for the apparatus and a second configuration for the aiding terminal device, and transmitting the second configuration to the aiding terminal device.

According to an eleventh aspect there is provided a computer program comprising instructions for causing an apparatus to perform at least the following: identify, using sidelink connectivity, an aiding terminal device for creating a cluster of collaborating terminal devices, wherein the cluster is capable of deploying a combined positioning and ranging session, create, using the sidelink connectivity, the cluster with the aiding terminal device, transmit an indication to a network entity, wherein the indication comprises information regarding the collaborating terminal devices comprised in the cluster and information indicating capabilities of the collaborating terminal devices comprised in the cluster, receive, from the network entity, assistance information for deploying the combined positioning and ranging session, wherein the assistance information comprises a first configuration for the apparatus and a second configuration for the aiding terminal device, and transmit the second configuration to the aiding terminal device.

According to a twelfth aspect there is provided a computer program comprising instructions stored thereon for performing at least the following: identifying, using sidelink connectivity, an aiding terminal device for creating a cluster of collaborating terminal devices, wherein the cluster is capable of deploying a combined positioning and ranging session, creating, using the sidelink connectivity, the cluster with the aiding terminal device, transmitting an indication to a network entity, wherein the indication comprises information regarding the collaborating terminal devices comprised in the cluster and information indicating capabilities of the collaborating terminal devices comprised in the cluster, receiving, from the network entity, assistance information for deploying the combined positioning and ranging session, wherein the assistance information comprises a first configuration for the apparatus and a second configuration for the aiding terminal device, and transmitting the second configuration to the aiding terminal device.

According to a thirteenth aspect there is provided a non-transitory computer readable medium comprising program instructions for causing an apparatus to perform at least the following: identify, using sidelink connectivity, an aiding terminal device for creating a cluster of collaborating terminal devices, wherein the cluster is capable of deploying a combined positioning and ranging session, create, using the sidelink connectivity, the cluster with the aiding terminal device, transmit an indication to a network entity, wherein the indication comprises information regarding the collaborating terminal devices comprised in the cluster and information indicating capabilities of the collaborating terminal devices comprised in the cluster, receive, from the network entity, assistance information for deploying the combined positioning and ranging session, wherein the assistance information comprises a first configuration for the apparatus and a second configuration for the aiding terminal device, and transmit the second configuration to the aiding terminal device.

According to a fourteenth aspect there is provided a non-transitory computer readable medium comprising program instructions stored thereon for performing at least the following: identifying, using sidelink connectivity, an aiding terminal device for creating a cluster of collaborating terminal devices, wherein the cluster is capable of deploying a combined positioning and ranging session, creating, using the sidelink connectivity, the cluster with the aiding terminal device, transmitting an indication to a network entity, wherein the indication comprises information regarding the collaborating terminal devices comprised in the cluster and information indicating capabilities of the collaborating terminal devices comprised in the cluster, receiving, from the network entity, assistance information for deploying the combined positioning and ranging session, wherein the assistance information comprises a first configuration for the apparatus and a second configuration for the aiding terminal device, and transmitting the second configuration to the aiding terminal device.

### LIST OF DRAWINGS

In the following, the invention will be described in greater detail with reference to the embodiments and the accompanying drawings, in which

FIG. 1 illustrates an example embodiment of a radio access network.

FIG. 2A, 2B and 2C illustrate example embodiments in which collaborating terminal devices forming a cluster are utilized.

FIG. 3 illustrates an example embodiment in which a cluster of collaborating terminal devices is utilized for positioning and ranging in a combine positioning and ranging session.

FIG. 4 and FIG. 5 illustrate example embodiments of an apparatus.

### DESCRIPTION OF EMBODIMENTS

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory (ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device. The above-described embodiments of the circuitry may also be considered as embodiments that provide means for carrying out the embodiments of the methods or processes described in this document.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via any suitable means. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments described herein may be implemented in a communication system, such as in at least one of the following: Global System for Mobile Communications (GSM) or any other second generation cellular communication system, Universal Mobile Telecommunication System (UMTS, 3G) based on basic wideband-code division multiple access (W-CDMA), high-speed packet access (HSPA), Long Term Evolution (LTE), LTE-Advanced, a system based on IEEE 802.11 specifications, a system based on IEEE 802.15 specifications, and/or a fifth generation (5G) mobile or cellular communication system. The embodiments are not, however, restricted to the system given as an example but a person skilled in the art may apply the solution to other communication systems provided with necessary properties.

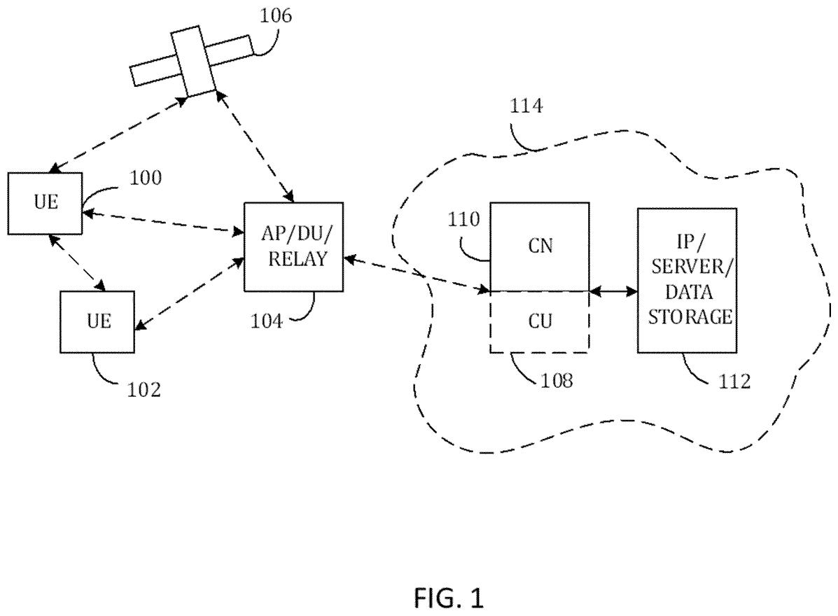

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may comprise also other functions and structures than those shown in FIG. 1. The example of FIG. 1 shows a part of an exemplifying radio access network.

FIG. 1 shows terminal devices 100 and 102 configured to be in a wireless connection on one or more communication channels in a cell with an access node (such as (e/g)NodeB) 104 providing the cell. The access node 104 may also be referred to as a node. The wireless link from a terminal device to a (e/g)NodeB is called uplink or reverse link and the wireless link from the (e/g)NodeB to the terminal device is called downlink or forward link. It should be appreciated that (e/g)NodeBs or their functionalities may be implemented by using any node, host, server or access point etc. entity suitable for such a usage. It is to be noted that although one cell is discussed in this exemplary embodiment, for the sake of simplicity of explanation, multiple cells may be provided by one access node in some exemplary embodiments.

A communication system may comprise more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The (e/g)NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 110 (CN or next generation core NGC). Depending on the system, the counterpart on the CN side may be a serving gateway (S-GW, routing and forwarding user data packets), packet data network gateway (P-GW), for providing connectivity of terminal devices (UEs) to external packet data networks, or mobile management entity (MME), etc.

The terminal device (also called UE, user equipment, user terminal, user device, etc.) illustrates one type of an apparatus to which resources on the air interface are allocated and assigned, and thus any feature described herein with a terminal device may be implemented with a corresponding apparatus, such as a relay node. An example of such a relay node is a layer 3 relay (self-backhauling relay) towards the base station. Another example of such a relay node is a layer 2 relay. Such a relay node may contain a terminal device part and a Distributed Unit (DU) part. A CU (centralized unit) may coordinate the DU operation via F1AP-interface for example.

The terminal device may refer to a portable computing device that includes wireless mobile communication devices operating with or without a subscriber identification module (SIM), or an embedded SIM, eSIM, including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be an exclusive or a nearly exclusive uplink only device, of which an example is a camera or video camera loading images or video clips to a network. A terminal device may also be a device having capability to operate in Internet of Things (IoT) network which is a scenario in which objects are provided with the ability to transfer data over a network without requiring human-to-human or human-to-computer interaction. The terminal device may also utilise cloud. In some applications, a terminal device may comprise a small portable device with radio parts (such as a watch, earphones or eyeglasses) and the computation is carried out in the cloud. The terminal device (or in some embodiments a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications such as (massive) machine-type communications (mMTC), including vehicular safety, different sensors and real-time control. 5G is expected to have multiple radio interfaces, namely below 6 GHz, cmWave and mmWave, and also being integratable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G may require bringing the content close to the radio which may lead to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, and/or utilise services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 104) and non-real time functions being carried out in a centralized manner (in a centralized unit, CU 108).

It should also be understood that the distribution of labour between core network operations and base station operations may differ from that of the LTE or even be non-existent. Some other technology that may be used includes for example Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling or service availability in areas that do not have terrestrial coverage. Satellite communication may utilise geostationary earth orbit (GEO) satellite systems, but also low earth orbit (LEO) satellite systems, for example, mega-constellations. A satellite 106 comprised in a constellation may carry a gNB, or at least part of the gNB, that create on-ground cells.

Alternatively, a satellite 106 may be used to relay signals of one or more cells to the Earth. The on-ground cells may be created through an on-ground relay node 104 or by a gNB located on-ground or in a satellite or part of the gNB may be on a satellite, the DU for example, and part of the gNB may be on the ground, the CU for example. Additionally, or alternatively, high-altitude platform station, HAPS, systems may be utilized.

It is to be noted that the depicted system is an example of a part of a radio access system and the system may comprise a plurality of (e/g)NodeBs, the terminal device may have an access to a plurality of radio cells and the system may comprise also other apparatuses, such as physical layer relay nodes or other network elements, etc. At least one of the (e/g)NodeBs may be a Home (e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto-or picocells. The (e/g)NodeBs of FIG. 1 may provide any kind of these cells. A cellular radio system may be implemented as a multilayer network including several kinds of cells. In some exemplary embodiments, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. A network which is able to use “plug-and-play” (e/g)NodeBs, may include, in addition to Home (e/g)NodeBs (H (e/g)nodeBs), a home node B gateway, or HNB-GW (not shown in FIG. 1). A HNB Gateway (HNB-GW), which may be installed within an operator's network may aggregate traffic from a large number of HNBs back to a core network.

As the amount of categories in which devices are capable of performing wireless communication is increasing, there are trends that indicate ever more terminal devices to be located in proximity of each other. For example, IoT devices may be co-located with terminal devices such as a mobile phones and/or household appliances. As another example, a terminal device such as mobile phone, may be in a car and may be connected to the car and/or other terminal devices such as a smart watch. The resources of the different terminal devices may vary and for example a smart watch or an loT device may have restrictions in terms of size, weight, power and cost which result in them having fewer resources compared to a mobile phone for example.

Collaborating terminal devices however may help to overcome what may be lacking in resources for some terminal devices. The collaboration may be understood as a method to improve network capability, i.e., support large throughput without single point resource consumption, which may improve coverage with 5GS resource efficiency, i.e., improve reliability without resource consumption during the period of good condition. Further, the collaboration may improve user experience by managing the terminal devices and communications in network style. Thus, collaborating terminal devices may be understood as devices that are connected to each other and which share resources for the benefit of at least one of the collaborating terminal devices. The resources may comprise hardware resources and/or software resources.

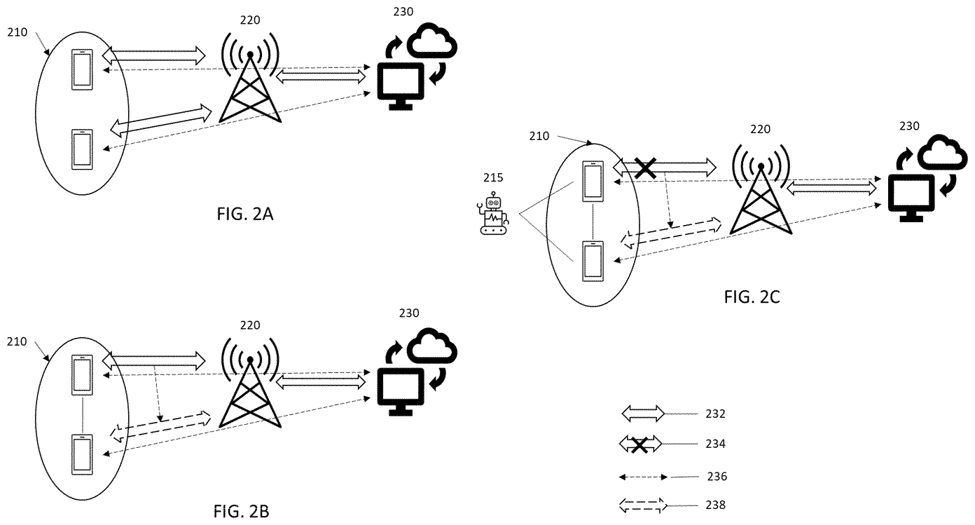

FIG. 2A, 2B and 2C illustrate example embodiments in which collaborating terminal devices forming a cluster 210 are utilized. The collaborating terminal devices comprised in the cluster 210 are connected to an access node 220 that is then connected to a core network 230. In FIG. 2B and 2C there is a direct link between the terminal devices while in FIG. 2A, there is no direct link between the collaborating terminal devices comprised in the cluster 210. In the FIGS. 2A, 2B, 2C the dashed arrows 236 illustrate 5G system signalling, the solid arrows 232 illustrate on-going media transmission to and from the core network, the dashed arrows 238 illustrate switched path and the crossed arrow 234 illustrates a failed path.

FIG. 2A illustrates an example embodiment of a use case of terminal device aggregation in which the terminal devices are aggregated such that UL throughput is improved in coverage limitation and UL transmission and DL reception may be separated from different terminal devices for UL boosting and power saving. FIG. 2B illustrates an example embodiment of a use case of service switching. Service switching enables fast switching of service across the collaborating terminal devices with no data loss. FIG. 2C illustrates as example embodiment of terminal device backup. In this exemplary embodiment the collaborating terminal devices comprised in the cluster 210 also connect to a third terminal device 215, which may be for example an automation device comprising an IoT device. The terminal device backup may improve reliability and robustness for ultra-reliable low latency communication (URLLC) use cases while saving radio resources. As may be understood from the example embodiments of FIG. 2A-2C, collaborating terminal devices may offer various benefits.

In order to be able to position a terminal device, various approaches may be used. For example, inter-frequency (IF) positioning measurements may be performed during IF measurement gaps (MG). The MGs may be configured by an entity of the network, such as an access node, to which the terminal device is connected to during a radio resource control (RRC) connected state, and the MGs may have a periodicity such as 20, 40, 60, 80, 120 ms with a duration no longer than 6 ms, which may correspond to approximately four positioning reference signal (PRS) subframes. An MG may be used by the terminal device to for example switch carrier frequency, perform positioning measurement on the new carrier and come back to the serving cell carrier. As mentioned, the MGs may be configured by the access node, which may be a serving gNB for example, according to requirements of a LTE positioning protocol (LPP) session. Such procedure is described for example in TS 38.331. However, it may be that MGs are allocated only if there is no ongoing data traffic to the terminal device, and thus some PRS measurements may be delayed until the terminal device becomes available. Using down prioritization of the PRS and/or carrier switching operations, such as carrier frequency offset compensation, beam selection, may introduce large latencies in the LPP positioning session which may the lead to the terminal device being unable to finalize the session within a target latency requirement. The target latency requirement may be for example 100 ms for some applications, and 10 ms for industrial IoT (IIoT) applications and vehicle to many (V2X) applications.

Terminal devices may be capable of connecting to one another without an access node being involved using sidelink (SL) connectivity. Sidelink connectivity may be beneficial in various use cases. For example, SL may be utilized when positioning a terminal device in use cases such as V2X, public safety, commercial usage and/or IIoT related use cases. SL may be utilized with various positioning methods such as time difference of arrival (TDOA), round trip time (RTT), angle of arrival (AOA) etc.

When positioning is to be performed for a terminal device that relates to automotive applications, there is a need for very low positioning latency without compromising accuracy of the positioning. For example, positioning session should be finalized within tens of milliseconds or less with accuracy of tens of centimetres. Additionally, V2X applications may require relative positioning to ensure road safety. For example, collisions with other vehicles, pedestrians or obstacles are to be avoided. To achieve this, for example ranging procedures with neighbouring devices, which may be held by pedestrians or may be mounted on vehicles for example, may be utilized. The ranging procedures may use SL connectivity. Achieving both high accuracy and low latency is thus required when at least some of the terminal devices involved in the positioning are moving. To achieve this, the positioning and the ranging sessions are to be reconfigurable such that selection of anchors for positioning, configuring transmissions of their positioning signals, such as sounding reference signal (SRS) or positioning reference signal (PRS), validating and deploying the configuration are reconfigurable. Additionally, different measurements are to be collected with sufficient accuracy and their receptions should also be sufficiently good over the channels used for collecting the measurements.

As positioning and ranging are to be performed simultaneously, a hybrid positioning and ranging session may be deployed. The hybrid positioning and ranging session thus may be understood as a combined positioning and ranging session. The hybrid positioning and ranging session may have strict latency constrains. As positioning and ranging sessions may operate under different regulations, for example in terms of spectrum usage, power control and interference, a terminal device that is target for the hybrid positioning and ranging session, that is the target terminal device, may need to adjust one or more of the following: carriers, transmission behaviour and/or measurement collection strategy. The adjusting may be needed for finalizing both sessions.

A terminal device, when comprised for example in a vehicle, may be a highly movable target terminal device for positioning. For performing a hybrid session for positioning and ranging (HPR) for such a target terminal device, a cluster of collaborating terminal devices may be utilized to enable the target terminal device to establish a strategy for the collaborating terminal devices to aid in the HPR session. The cluster is then seen from the perspective of a network entity such as an access node or a location management function (LMF), as a single terminal, which may be called as a hybrid terminal device (HT), and which has flexible-duplexing capability, i.e. the HT is able to perform simultaneous SL ranging and UL/DL positioning.

In an example embodiment, a target terminal device is a terminal device capable of a HPR session. The terminal device may be for example a highly mobile terminal device. The terminal device in this example embodiment is capable of discovering collaborating terminal devices for forming a cluster of collaborating terminal devices and vetting them based on their capabilities such as supporting SL, battery limitation and/or clock synchronization sources, and/or their proximity to the target terminal device. The target terminal device is also capable of establishing a collaboration strategy in this example embodiment.

To be able to use an HPR session, by the target terminal device, in this example embodiment, the collaboration strategy may be established using LTE Positioning Protocol (LPP) and SL signalling. The establishing may begin with a localization request of the target terminal device being transmitted from an LMF to the target terminal device. The request may be transmitted for example via LPP signalling. After transmitting the request, the collaborating terminal devices, which may also be called as aiding terminal devices, that form the cluster together with the target terminal device, are identified. The identification may be performed using SL signalling from the target terminal device to terminal devices that are candidates for becoming aiding terminal devices in the cluster of collaborating terminal devices. After this, the cluster may be created for the HPR. The cluster may be created for example by using SL signalling that is coordinated by the target terminal device.

Once the collaboration strategy has been established, in this example embodiment, the target terminal device may transmit to the LMF information that indicates the terminal devices comprised in the cluster, capabilities of the terminal devices regarding positioning and/or ranging, and preferred roles per collaborating terminal device. The capabilities regarding ranging and/or positioning may comprise capabilities regarding supported carriers, bandwidths etc. The preferred roles per collaborating terminal device may be used to indicate which functionality is to be performed by which terminal device. For example, which terminal device is to perform SL ranging, and/or which one is to perform UL positioning.

Next, in this example embodiment, the LMF defines configurations for the collaborating terminal devices. This may be performed based on the received information that indicates the terminal devices comprised in the cluster, capabilities of the terminal devices regarding positioning and/or ranging, and preferred roles per collaborating terminal device. The configurations may be used to establish roles for each of the collaborating terminal devices in the cluster. In the defined configurations, the type of session(s) is defined for each collaborating terminal device in the cluster. For example, positioning or ranging UL, DL, RTT, or SL, such as PRS and/or SRS code and the associated time-frequency-space resources. The configurations may also define validity of the positioning and ranging sessions and a strategy for collecting measurements, in other words, a strategy for reporting measurements. The strategy for collecting measurements may be for example hierarchical, flat or a combination of both. If the measurement collection strategy is hierarchical, then all collaborators may report back to the target terminal device via SL and the target terminal device then may then transmit a report that is a cumulative report of all the measurements to the LMF using LPP. In a flat strategy for measurement collection, each collaborating terminal device transmits their respective measurements to the LMF via their own LPP signalling. If a combined measurement collection strategy is used, then some of the aiding terminal devices report their measurement results to the target terminal device, which then transmits those along with its own measurement results to the LMF, while some other aiding terminal devices report their respective measurement results to the LMF via their own LPP signalling.

Once the configurations for the collaborating terminal devices have been defined, in this example embodiment, the LMF may transmit signalling to and from the access nodes that serve one or more of the collaborating terminal devices that form the cluster. The signalling may be performed via new radio positioning protocol, NRPP, signalling and it may request deployment of selected sessions, such as positioning or ranging sessions. Using the signalling between the LMF and the serving access nodes, selected SRS resources may be assigned for positioning, and/or SL ranging strategy may be implemented. The SL ranging strategy may be for example SL mode 1 or SL mode 2. In mode 1, resources of a terminal device are configured and released using radio resource control (RRC) signalling between the terminal device and its serving access node. In mode 2, the resources of a terminal device are reserved and release in an autonomous manner without a serving access node being involved. The terminal device may use a sensing procedure for selecting and releasing its resources

Next, in this example embodiment, LPP assistance data is transmitted from the LMF to the target terminal device to inform the target terminal device regarding HPR configuration selected by the LMF and agreed with the serving access nodes. After this, there is SL signalling from the target terminal device to the aiding terminal devices. This signalling may be used to instruct the configurations defined by the LMF. Finally, in this example embodiment, there is SL broadcast from the target terminal device to the aiding terminal devices. This broadcast may comprise results of ranging such that those may be used by the aiding terminal devices in configuring their future positioning and/or ranging sessions for example.

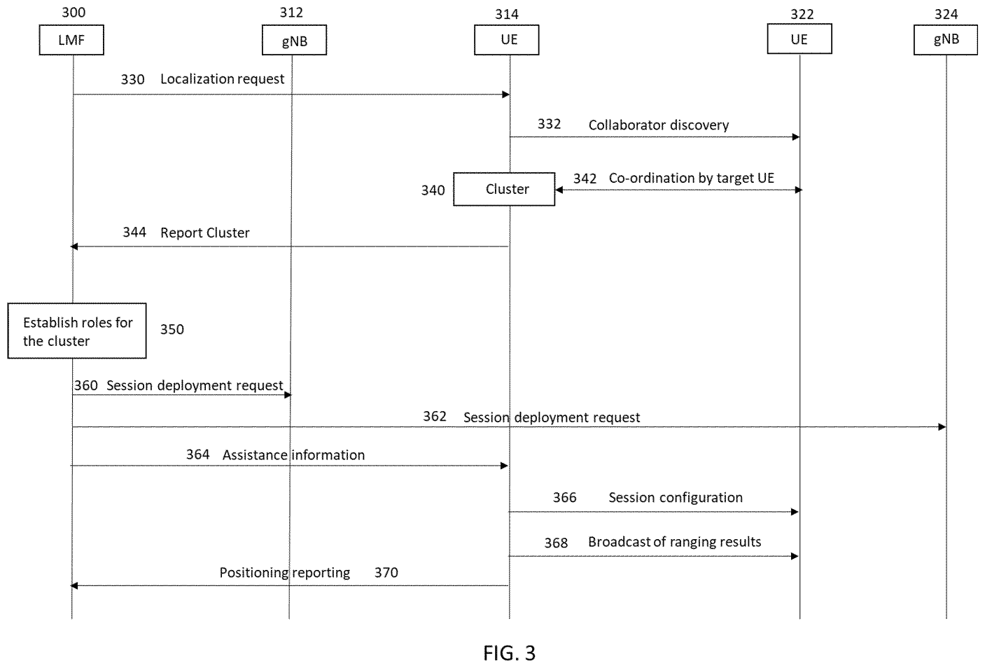

FIG. 3 illustrates an example embodiment in which a cluster of collaborating terminal devices is utilized for positioning and ranging in a HPR session. In this example embodiment, there is first a localization request 330 transmitted form an LMF 300 to a target terminal device 314. The target terminal device in this example embodiment is served by the access node 312, which in this example embodiment is a gNB. After receiving the request 330 for localization, the target terminal device 314 may proceed to transmit a SL signalling to discover 332 candidate terminal devices for becoming an aiding terminal device in a cluster of collaborating terminal devices. Thus, the target terminal device 314 transmits sidelink discovery 332 to another terminal device, which, in this example embodiment is an aiding terminal device. 322. The aiding terminal device is served by the access node 324, which in this example embodiment is a gNB. Using SL signalling 342 to and from the aiding terminal device 322, the target terminal device 314 then creates 340 the cluster for the HPR session.

Once the cluster is created, the target terminal device 314 transmits a report 344 to the LMF 300 indicating the terminal devices comprised in the cluster as well as their capabilities and roles. A role of a terminal device may be understood as one or more functionalities comprised in the HPR session and assigned to the terminal device for performing.

The LMF 300 in this example embodiment then defines a configuration for each terminal device comprised in the cluster that was created by the target terminal device 314. In the cluster, in this example embodiment, there is the target terminal device 314 and the aiding terminal device 322, but it is to be noted that alternatively there could be additional aiding terminal devices as well. Thus, in this example embodiment, the LMF 300, which may be considered as a network entity, defines 350 a configuration for the target terminal device 314 and another configuration for the aiding terminal device 322. A configuration may define for example the type of positioning and/or ranging sessions, validity of positioning and/or ranging sessions as well as a strategy for collecting measurements. In other words, the LMF 300 defines configurations that define which functionality is to be performed by which terminal device such that both positioning and ranging may be performed simultaneously by the cluster of collaborating terminal devices. Thus, the target terminal device 314 may perform at least one functionality in accordance with the configuration defined for it. Also, the aiding terminal device 322 may perform at least one functionality in accordance with the configuration defined for it. For example, the target terminal device 314 may receive a configuration that configures it for performing functionality comprising positioning, such as UL or DL using PRS and/or SRS, while the aiding terminal device 322 receives a configuration that configures it for performing functionality comprising ranging, or vice versa.

Once the configurations have been defined, the LMF 300 transmits a request 360 for a HPR session to the access node 312 serving the target terminal device 314 and a request 362 for the HPR session to the access node 324 serving the aiding terminal device 322. After this, the LMF 300 transmits information regarding the defined configurations to the target terminal device 314, which then forwards 366 to the aiding terminal device 322 its respective configuration defined by the LMF 300. Next, the target terminal device 314 broadcasts 368 its ranging results to the aiding terminal device 322. The target terminal device 314 then transmits 370 to the LMF 300 a report regarding positioning. The report, which may be understood as a positioning report, comprises measurements in accordance with the selected strategy for reporting measurements. Optionally, in case the measurements received from the aiding terminal device 322 require compensation, the LMF 300 may perform required compensation or the target terminal device 314 may perform the required compensations. For example, the distance between the target terminal device 314 and the aiding terminal device 322 may need to be compensated for in case the aiding terminal device performs ranging. For example, this may mean that the target terminal 314 modifies the measurements obtained from the aiding terminal device 322 based on the distance between said terminals 314 and 322. Thus, the reported compensated measurements may more accurately be associated with the location of the target terminal device 314.

Thus, as described in the FIG. 3, the target terminal device 314 uses SL signalling to discover aiding terminal device(s) and then creates a cluster of collaborating terminal devices for deploying the HPR session. The target terminal device 314 and MF 300 then assign and disseminate roles of each collaborating terminal device comprised in the cluster for the HPR session. In other words, the assign the one or more functionalities to be performed by each of the collaborating terminal devices comprised in the cluster during the HPR session. The LMF 300 also transmits signalling to the serving access nodes of the collaborating terminal devices comprised in the cluster for assigning resources to collaborators, e.g. defining and granting necessary measurement gaps. The target terminal device 314 in the example embodiment of FIG. 3 creates the cluster and selects the collaborating terminal device(s) for the cluster for the deployment of the HPR session. The LMF 300 may then assign roles for each collaborating terminal device and also communicate to their respective serving access nodes the roles and thus get an acceptance from the serving access nodes to for the assigned roles. In other words, the serving access nodes accept a reconfiguration of an aiding terminal device for a purpose of aiding the target terminal device 314. This acceptance may comprise for example reserving specific time resource of the aiding terminal device, assigning measurement gaps, etc.

As mentioned previously, a role may be understood as performing a functionality in accordance with the received configuration during the HPR session. The functionality may comprise for example aiding with ranging operations, aiding with positioning operations, aiding with both ranging and positioning operations and/or transferring own measurements to the target terminal device 314, or to the LMF 300 directly.

It is to be noted that in some example embodiments, in a cluster of collaborating terminal devices there may be more than one aiding terminal device. When there are more than one aiding terminal devices, the configuration defined for the one aiding terminal device may be transmitted to the one aiding terminal device and also to at least some of the other aiding terminal devices comprised in the cluster. Additionally, in some example embodiments, a configuration determined for a target terminal device may be transmitted to one or more aiding terminal devices comprised in the cluster.

It is also to be noted that in some example embodiments, a positioning report may comprise measurement that are received from a plurality of aiding terminal devices and are transmitted as such, in other words, as raw measurements, to a network entity such as an LMF. Alternatively, the measurements may be combined such that they form a fusion of measurements that is then comprised in the positioning report. The fusion may be performed by the target terminal device that receives the measurements form the plurality of aiding terminal devices.

The example embodiments described above may have benefits such as enabling dual positioning and ranging capability at a V2X device regardless of its duplexing limitations and/or capabilities. Further, the example embodiments described above may have a benefit of reducing the required number of measurement gaps, since the target device does not need to change carriers and/or bandwidths to perform both functions.

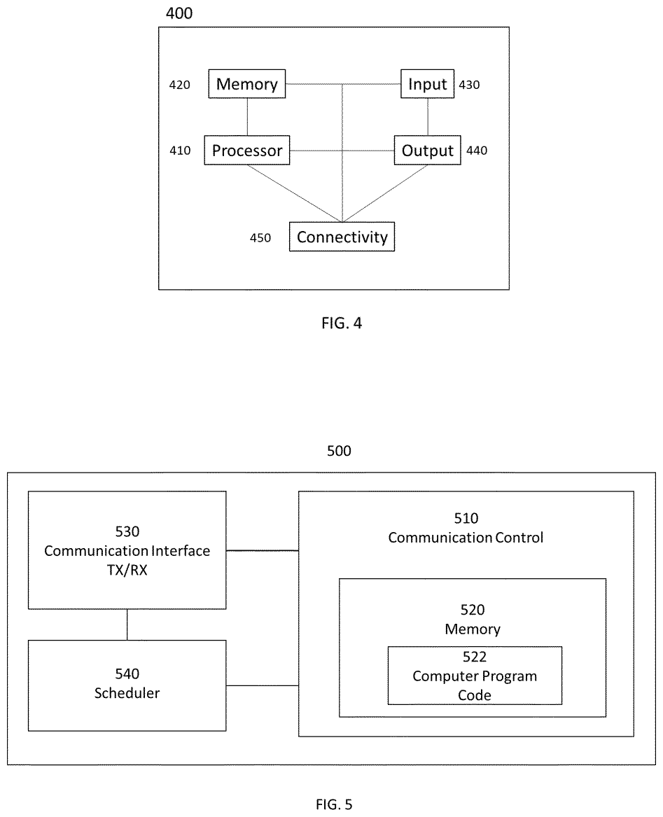

FIG. 4 illustrates an apparatus 400, which may be an apparatus such as, or comprised in, a terminal device, according to an example embodiment. The apparatus 400 comprises a processor 410. The processor 410 interprets computer program instructions and processes data. The processor 410 may comprise one or more programmable processors. The processor 410 may comprise programmable hardware with embedded firmware and may, alternatively or additionally, comprise one or more application specific integrated circuits, ASICs.

The processor 410 is coupled to a memory 420. The processor is configured to read and write data to and from the memory 420. The memory 420 may comprise one or more memory units. The memory units may be volatile or non-volatile. It is to be noted that in some example embodiments there may be one or more units of non-volatile memory and one or more units of volatile memory or, alternatively, one or more units of non-volatile memory, or, alternatively, one or more units of volatile memory. Volatile memory may be for example RAM, DRAM or SDRAM. Non-volatile memory may be for example ROM, PROM, EEPROM, flash memory, optical storage or magnetic storage. In general, memories may be referred to as non-transitory computer readable media. The memory 420 stores computer readable instructions that are execute by the processor 410. For example, non-volatile memory stores the computer readable instructions and the processor 410 executes the instructions using volatile memory for temporary storage of data and/or instructions.

The computer readable instructions may have been pre-stored to the memory 420 or, alternatively or additionally, they may be received, by the apparatus, via electromagnetic carrier signal and/or may be copied from a physical entity such as computer program product. Execution of the computer readable instructions causes the apparatus 400 to perform functionality described above.

In the context of this document, a “memory” or “computer-readable media” may be any non-transitory media or means that can contain, store, communicate, propagate or transport the instructions for use by or in connection with an instruction execution system, apparatus, or device, such as a computer.

The apparatus 400 further comprises, or is connected to, an input unit 430. The input unit 430 comprises one or more interfaces for receiving a user input. The one or more interfaces may comprise for example one or more motion and/or orientation sensors, one or more cameras, one or more accelerometers, one or more microphones, one or more buttons and one or more touch detection units. Further, the input unit 430 may comprise an interface to which external devices may connect to.

The apparatus 400 also comprises an output unit 440. The output unit comprises or is connected to one or more displays capable of rendering visual content such as a light emitting diode, LED, display, a liquid crystal display, LCD and a liquid crystal on silicon, LCoS, display. The output unit 440 further comprises one or more audio outputs. The one or more audio outputs may be for example loudspeakers or a set of headphones.

The apparatus 400 may further comprise a connectivity unit 450. The connectivity unit 450 enables wired and/or wireless connectivity to external networks. The connectivity unit 450 may comprise one or more antennas and one or more receivers that may be integrated to the apparatus 400 or the apparatus 400 may be connected to. The connectivity unit 450 may comprise an integrated circuit or a set of integrated circuits that provide the wireless communication capability for the apparatus 400. Alternatively, the wireless connectivity may be a hardwired application specific integrated circuit, ASIC.

It is to be noted that the apparatus 400 may further comprise various component not illustrated in the FIG. 4. The various components may be hardware component and/or software components.

The apparatus 500 of FIG. 5 illustrates an example embodiment of an apparatus that may be an access node or be comprised in an access node. The apparatus may be, for example, a circuitry or a chipset applicable to an access node to realize the described embodiments. The apparatus 500 may be an electronic device comprising one or more electronic circuitries. The apparatus 500 may comprise a communication control circuitry 510 such as at least one processor, and at least one memory 520 including a computer program code (software) 522 wherein the at least one memory and the computer program code (software) 522 are configured, with the at least one processor, to cause the apparatus 500 to carry out any one of the example embodiments of the access node described above.

The memory 520 may be implemented using any suitable data storage technology, such as semiconductor-based memory devices, flash memory, magnetic memory devices and systems, optical memory devices and systems, fixed memory and removable memory. The memory may comprise a configuration database for storing configuration data. For example, the configuration database may store current neighbour cell list, and, in some example embodiments, structures of the frames used in the detected neighbour cells.

The apparatus 500 may further comprise a communication interface 530 comprising hardware and/or software for realizing communication connectivity according to one or more communication protocols. The communication interface 530 may provide the apparatus with radio communication capabilities to communicate in the cellular communication system. The communication interface may, for example, provide a radio interface to terminal devices. The apparatus 500 may further comprise another interface towards a core network such as the network coordinator apparatus and/or to the access nodes of the cellular communication system. The apparatus 500 may further comprise a scheduler 540 that is configured to allocate resources.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1-24. (canceled)

25. An apparatus comprising at least one processor, and at least one memory including computer program instructions, that when executed by the at least one processor, cause the apparatus to:
receive, from a first terminal device, an indication comprising information regarding a cluster comprising the first terminal device and a second terminal device, wherein the cluster is capable of performing a combined positioning and ranging session;
define, based on the indication, for the combined positioning and ranging session, a first configuration for the first terminal device and a second configuration for the second terminal device, the first configuration and the second configuration define which functionality is to be performed by which terminal device such that both positioning and ranging are performed simultaneously by the cluster, wherein the first configuration is defined based on a first role assigned to the first terminal device for the combined positioning and ranging session, and the second configuration is defined based on a second role assigned to the second terminal device for the combined positioning and ranging session;
transmit a first request for deploying the combined positioning and ranging session to a first access node serving the first terminal device, and a second request for deploying the combined positioning and ranging session to a second access node serving the second terminal device;
receive a first acceptance to the first request from the first access node a second acceptance regarding the second request from the second access node, before transmitting the first configuration and the second configuration to the first terminal device; and
transmit, to the first terminal device, for deployment of the combined positioning and ranging session, assistance information comprising the first configuration, the second configuration, and for the first and the second configuration, a type of their respective positioning and ranging session and a validity of their respective positioning and ranging session.

26. The apparatus according to claim 25, wherein the indication further comprises information indicating capabilities of the first terminal device and the second terminal device.

27. The apparatus according to claim 26, wherein the first role and the second role are comprised in the indication received from the first terminal device.

28. The apparatus according to claim 27, wherein the apparatus is further caused to receive a positioning report from the first terminal device based, at least partly, on the measurements received from the second terminal device.

29. The apparatus according to claim 28, wherein the apparatus is further caused to perform, based on the second terminal device performing ranging, compensation for the measurements received from the first terminal device based on a distance between the first terminal device and the second terminal device.

30. The apparatus according to claim 29, wherein the apparatus is comprised in a network entity comprising a location management function.

31. The apparatus according to claim 30, wherein the assistant information further comprises measurement collection strategy.

32. A system comprising:
an apparatus;
at least one processor; and
at least one memory including computer program instructions, that when executed by the at least one processor, cause the apparatus to:
receive, from a first terminal device, an indication comprising information regarding a cluster comprising the first terminal device and a second terminal device, wherein the cluster is capable of performing a combined positioning and ranging session;
define, based on the indication, for the combined positioning and ranging session, a first configuration for the first terminal device and a second configuration for the second terminal device, the first configuration and the second configuration define which functionality is to be performed by which terminal device such that both positioning and ranging are performed simultaneously by the cluster, wherein the first configuration is defined based on a first role assigned to the first terminal device for the combined positioning and ranging session, and the second configuration is defined based on a second role assigned to the second terminal device for the combined positioning and ranging session;
transmit a first request for deploying the combined positioning and ranging session to a first access node serving the first terminal device, and a second request for deploying the combined positioning and ranging session to a second access node serving the second terminal device;
receive a first acceptance to the first request from the first access node a second acceptance regarding the second request from the second access node, before transmitting the first configuration and the second configuration to the first terminal device; and
transmit, to the first terminal device, for deployment of the combined positioning and ranging session, assistance information comprising the first configuration, the second configuration, and for the first and the second configuration, a type of their respective positioning and ranging session and a validity of their respective positioning and ranging session.

33. The apparatus according to claim 32, wherein the indication further comprises information indicating capabilities of the first terminal device and the second terminal device.

34. The apparatus according to claim 33, wherein the first role and the second role are comprised in the indication received from the first terminal device.

35. The apparatus according to claim 34, wherein the apparatus is further caused to receive a positioning report from the first terminal device based, at least partly, on the measurements received from the second terminal device.

36. The apparatus according to claim 35, wherein the apparatus is further caused to perform, based on the second terminal device performing ranging, compensation for the measurements received from the first terminal device based on a distance between the first terminal device and the second terminal device.

37. The apparatus according to claim 36, wherein the apparatus is comprised in a network entity comprising a location management function.

38. The apparatus according to claim 37, wherein the assistant information further comprises measurement collection strategy.

39. A method comprising:
receiving, by an apparatus from a first terminal device, an indication comprising information regarding a cluster comprising the first terminal device and a second terminal device, wherein the cluster is capable of performing a combined positioning and ranging session;
defining, based on the indication, for the combined positioning and ranging session, a first configuration for the first terminal device and a second configuration for the second terminal device, the first configuration and the second configuration define which functionality is to be performed by which terminal device such that both positioning and ranging are performed simultaneously by the cluster, wherein the first configuration is defined based on a first role assigned to the first terminal device for the combined positioning and ranging session, and the second configuration is defined based on a second role assigned to the second terminal device for the combined positioning and ranging session;
transmitting a first request for deploying the combined positioning and ranging session to a first access node serving the first terminal device, and a second request for deploying the combined positioning and ranging session to a second access node serving the second terminal device;
receiving a first acceptance to the first request from the first access node a second acceptance regarding the second request from the second access node, before transmitting the first configuration and the second configuration to the first terminal device; and
transmitting, to the first terminal device, for deployment of the combined positioning and ranging session, assistance information comprising the first configuration, the second configuration, and for the first and the second configuration, a type of their respective positioning and ranging session and a validity of their respective positioning and ranging session.

40. The method according to claim 39, wherein the indication further comprises information indicating capabilities of the first terminal device and the second terminal device.

41. The method according to claim 40, wherein the first role and the second role are comprised in the indication received from the first terminal device.

42. An method according to claim 41, further comprising receiving a positioning report from the first terminal device based, at least partly, on the measurements received from the second terminal device.

43. The method according to claim 42, further comprising performing, based on the second terminal device performing ranging, compensation for the measurements received from the first terminal device based on a distance between the first terminal device and the second terminal device.

44. The method according to claim 43, wherein the assistant information further comprises measurement collection strategy.
